(19) United States
(12) Patent Application Publication
(10) Pub. No.: US 2024/0289636 A1
(43) Pub. Date: Aug. 29, 2024

(54) METHOD, ELECTRONIC DEVICE AND STORAGE MEDIUM FOR TRAINING FEDERATED LEARNING MODEL

(71) Applicant: Beijing Bytedance Network Technology Co., Ltd., Beijing (CN)

(72) Inventors: Yunfei Lu, Beijing (CN); Yang Liu, Beijing (CN); Huitian Zheng, Beijing (CN); Cong Wang, Beijing (CN); Ye Wu, Beijing (CN)

(21) Appl. No.: 18/572,935

(22) PCT Filed: Feb. 24, 2023
(86) PCT No.: PCT/CN2023/078224

§ 371 Date: Dec. 21, 2023

(30) Foreign Application Priority Data
Mar. 14, 2022 (CN) 202210249166.1

(51) Int. Cl. G06N 3/098

(52) U.S. Cl. CPC G06N 3/098

(57) ABSTRACT

The disclosure provides a method, an electronic device, and a storage medium for training a federated learning model. According to the method, the electronic device, and the storage medium for training a federated learning model provided in the disclosure, after each of participant devices obtains gradient information of the participant device by performing joint encryption training with a rest of the participant devices, the participant device performs joint training with the rest of the participant devices based on a model parameter variation and a gradient information variation, to obtain a corresponding gradient search direction; then a target participant device of the participant device calculates step information based on the gradient search direction and a model loss function; finally, each of the participant devices updates a model parameter of the participant device based on the gradient search direction and the step information.

This application claims the benefit to the Chinese Patent Application No. 202210249166.1, entitled “METHOD, ELECTRONIC DEVICE AND STORAGE MEDIUM FOR TRAINING FEDERATED LEARNING MODEL” filed on Mar. 14, 2022, which is hereby incorporated by reference in its entirety.

### FIELD

Embodiments of the disclosure relate to the technical field of artificial intelligence, and more particularly to a method, an electronic device and a storage medium for training a federated learning model.

### BACKGROUND

With the development of computer technology and the advancement of artificial intelligence technology, federated learning has been widely used. In federated learning, a plurality of participants with different service data collaborate to complete the training of federated learning models.

In the federated learning model, a stochastic gradient descent approach (SGD), a Newton approach, and a quasi-Newton approach are generally used to optimize the model.

However, a convergence speed of the stochastic gradient descent method is slow, and computational complexity of the second derivative used in the Newton approach and quasi-Newton approach is high.

### SUMMARY

In view of this, the purpose of the disclosure is to propose a method, an electronic device, and a storage medium for training a federated learning model.

Based on the above purpose, the disclosure provides a method of training a federated learning model, including:
any participant device of participant devices performing joint encryption training with a rest of the participant devices based on a model parameter and feature information of the participant device to obtain gradient information of the participant device;
any participant device acquiring a model parameter variation and a gradient information variation based on the model parameter and the gradient information, and performing a predetermined number of rounds of interactive calculations with the rest of the participant devices based on the model parameter variation and the gradient information variation to obtain a gradient search direction of the participant device as a quasi-Newton condition;
the target participant device of the participant devices acquiring a model loss function, and calculating step information based on the gradient search direction and the model loss function; where the target participant device is a participant device having label information among the participant devices, and the model loss function is a convex function; and
any participant device of the participant devices updating the model parameter of the participant device based on the gradient search direction and the step information, until the federated learning model converges.

Any participant device of the participant devices performing the predetermined number of rounds of interactive calculations with the rest of the participant devices using a bidirectional recursion approach based on the model parameter variation and the gradient information variation to obtain the gradient search direction as the quasi-Newton condition includes:
any participant device of the participant devices performing the predetermined number of rounds of interactive calculations with the rest of the participant devices based on the model parameter variation and the gradient information variation to obtain an intermediate variation; where the intermediate variation is used to characterize a magnitude of the gradient information; and
any participant device of the participant devices performing the predetermined number of rounds of interactive calculations with the rest of the participant devices based on the intermediate variation, to obtain the gradient search direction.

Alternatively, any participant device of the participant devices performing the predetermined number of rounds of interactive calculations with the rest of the participant devices based on the model parameter variation and the gradient information variation to obtain the intermediate variation further includes:
any participant device of the participant devices calculating first intermediate value information of the participant device based on the model parameter variation and the gradient information variation of the participant device, exchanging the first intermediate value information with the rest of the participant devices, and calculating a first global intermediate value based on the first intermediate value information of respective participant devices of the participant devices to calculate the intermediate variation based on the first global intermediate value.

Alternatively, the first intermediate value information is obtained based on a product of a transpose matrix of the gradient information variation and the model parameter variation.

Alternatively, any participant device of the participant devices performing the predetermined number of rounds of interactive calculations with the rest of the participant devices based on the intermediate variation to obtain the gradient search direction further includes:
any participant device calculating second intermediate value information of the participant device based on the intermediate variation of the participant device; and
any participant device exchanging the second intermediate value information with the rest of the participant devices based on the second intermediate value information of the participant device and calculating a second global intermediate value based on the second intermediate value information of respective participant devices of the participant devices to calculate the gradient search direction based on the second global intermediate value.

Alternatively, any participant device of the participant devices calculating the second intermediate value information of the participant device based on the intermediate variation of the participant device includes:
any participant device of the participant devices obtaining first scalar information based on a transpose matrix of the model parameter variation and the model parameter variation, and obtaining second scalar information based on a transpose matrix of the gradient information variation and the gradient information variation;
any participant device of the participant devices interacting with the rest of the participant devices to obtain third scalar information and fourth scalar information of the rest of the participant devices; where the third scalar information is obtained based on a transpose matrix of a model parameter variation and the model parameter variation of the rest of the participant devices, and the fourth scalar information is obtained based on a transpose matrix of a gradient information variation and the gradient information variation of the rest of the participant devices; and
any participant device of the participant devices calculating the second intermediate value information based on the first scalar information, the second scalar information, the third scalar information, the fourth scalar information and the intermediate variation.

Alternatively, the first global intermediate value is a sum of the first intermediate value information of respective participant devices of the participant devices, and the second global intermediate value is a sum of the second intermediate value information of respective participant devices of the participant devices.

Alternatively, the target participant device of the participant devices acquiring the model loss function, and calculating the step information based on the gradient search direction and the model loss function includes:
the target participant device of the participant devices acquiring sample label information, and obtaining sample label prediction information based on a model parameter and the feature information of the target participant device and first data information of the rest of the participant devices; where the first data information is obtained based on the model parameter and the feature information of the rest of the participant devices;
the target participant device of the participant devices calculating the model loss function based on the sample label prediction information and the sample label information; and
the target participant device determining whether the model loss function satisfies a predetermined condition; based on the model loss function satisfying the predetermined condition, determining current step information as final step information; based on the model loss function dissatisfying the predetermined condition, reducing a value of the step information and recalculating the model loss function.

Alternatively, obtaining the sample label prediction information based on the model parameter, the feature information, and the data information of the rest of the participant devices includes:
the target participant device of the participant devices calculating a product of a transpose matrix of the model parameter and the feature information based on the model parameter and the feature information of the target participant device to obtain the second data information;
the target participant device interacting with the rest of the participant devices based on the second data information to obtain the first data information of the rest of the participant devices; and
the target participant device obtaining the sample label prediction information based on the first data information, the second data information and a predetermined model function.

The disclosure also provides an electronic device including a memory, a processor, and a computer program stored on the memory and executable on the processor, the processor, when executing the program, implementing any of the methods described above.

The disclosure also provides a non-transitory computer-readable storage medium that stores computer instructions for causing a computer to perform any of the methods described above.

As can be seen from the above, according to the method, electronic device, and storage medium for training a federated learning model provided by the disclosure, after each of participant devices obtains gradient information of the participant device by performing joint encryption training with a rest of the participant devices, the participant device performs joint training with the rest of the participant devices based on a model parameter variation and the gradient information variation, to obtain a corresponding gradient search direction; then, a target participant device of the participant devices calculates step information based on the gradient search direction and a model loss function; finally, each of the participant devices updates model parameter of the participant device based on the gradient search direction and the step information, without a calculation of an inverse matrix of a Hessian matrix.

Compared with a stochastic gradient descent approach, a Newton approach, and a quasi-Newton approach, calculations and communications are less, and fast convergence can be ensured.

### BRIEF DESCRIPTION OF THE DRAWINGS

For more clear illustration of the technical solutions in this disclosure or the related technology, the drawings that need to be used in the embodiments or related technical descriptions will be briefly introduce below. Obviously, the drawings described below are only embodiments of this disclosure. For those skilled in the art, other drawings can be obtained without creative labor based on these drawings.

FIG. 1 is a flowchart of a method of training the federated learning model according to an embodiment of the disclosure;

FIG. 2 is a schematic diagram of a framework of the federated learning model according to an embodiment of the disclosure;

FIG. 3 is a schematic diagram of sample information of the federated learning model according to an embodiment of the disclosure;

FIG. 4 is a flowchart of a method for acquiring gradient information by any participant device according to an embodiment of the disclosure;

FIG. 5 is a flowchart of a method for acquiring a gradient search direction according to an embodiment of the disclosure;

FIG. 6 is a schematic diagram of a structure of an electronic device according to an embodiment of the disclosure.

### DETAILED DESCRIPTION

For more clarity and understandability of objectives, technical solutions, and advantages of this disclosure, the disclosure will be further explained with respect to the detailed embodiments and the drawings.

It should be noted that unless otherwise defined, the technical or scientific terms used in the disclosure should be understood by those with ordinary skills in the field to which the disclosure belongs. The terms “first” and “second”, and the similar terms used in the disclosure do not indicate any order, quantity, or importance, but are only used to distinguish different components. The term “including” or “containing” or a similar term means that the components or objects that appear before the term cover the components or objects listed after the word and their equivalents, and do not exclude other components or objects. The term “connecting” or “connected” or a similar term is not limited to physical or mechanical connections, but can include electrical connections, either direct or indirect. The term “up”, “down”, “left”, “right”, and/or the like is only used to indicate a relative position relation. When the absolute position of the described object changes, the relative position relation may also change accordingly.

Artificial intelligence (AI) is a theory, method, technology, and application system that uses digital computers or machines controlled by digital computers to simulate, extend, and expand human intelligence, perceive the environment, acquire knowledge, and use knowledge to achieve the best results. In other words, artificial intelligence is a comprehensive technology in computer science that attempts to understand the essence of intelligence and produce a new intelligent machine that can react in a way similar to human intelligence. Artificial intelligence is to study the design principles and implementation methods of various intelligent machines and enable machines to have the functions of perception, reasoning and decision-making.

Artificial intelligence technology is a comprehensive subject that covers a wide range of fields, including both hardware and software technologies. The basic technologies of artificial intelligence generally include sensors, dedicated artificial intelligence chips, cloud services, distributed storage, big data processing technology, operation/interaction systems, mechatronics and other technologies. Artificial intelligence software technology mainly includes a computer vision technology, a speech processing technology and a natural language processing technology and involves several major aspects of machine learning/deep learning, autonomous driving, intelligent transportation and/or the like.

Machine learning (ML) is an interdisciplinary subject that involves a plurality of subjects such as a probability theory, statistics, an approximation theory, convex analysis, and an algorithmic complexity theory. It specializes in studying how computers simulate or implement human learning behaviors, to acquire new knowledge or skills and reorganize existing knowledge structures to continuously improve their performance. Machine learning is a core of artificial intelligence and a fundamental way to make computers intelligent. Its applications are widespread in various fields of artificial intelligence. Machine learning and deep learning generally include technologies such as artificial neural networks, belief networks, reinforcement learning, transfer learning, inductive learning, and teaching learning.

With the rapid development of machine learning, machine learning can be applied to various fields, such as data mining, computer vision, natural language processing, biometric recognition, medical diagnosis, detection of credit card fraud, securities market analysis, and DNA sequencing. Compared with traditional machine learning approaches, a deep neural network is a newer technology that establishes machine learning models with a multi-gradient network structure and automatically learns representation features from data. Due to its ease of use and good practical effect, it has been widely used in image recognition, automatic speech recognition, natural language processing, search recommendation and other fields.

Federated learning, also known as federated machine learning, joint learning, alliance learning, etc. Federated machine learning is a machine learning framework where all participants jointly establish a machine learning model, and only exchange intermediate data during training, without directly exchanging respective service data of the participants.

Specifically, assuming that Enterprise A and Enterprise B each establish a task model, a single task can be classification or prediction, and when obtaining data, these tasks have already been verified by their respective users. However, due to data incompletion, such as absence of label data at Enterprise A, absence of feature data at Enterprise B lacking feature data, or data insufficiency, the sample size is not enough to establish a good model, so the model at each end may not be established or the effect may not be ideal. The problem that federated learning needs to solve is how to establish a high-quality machine learning model at each end of A and B, which is trained using data from various enterprises such as A and B, and data owned by each enterprise is not known to other participants, that is, how to establish a shared model without exchanging their own data. This shared model is like the optimal model established by aggregating data from all participants. In this way, the built model only serves its own goals in each participant region.

The implementation architecture of federated learning includes at least two participant devices, each of which can include different service data, and can also participate in joint training of models through devices, computers, servers, etc; where each participant device can include at least one of one server, a plurality of servers, a cloud service platform, and a virtualization center. The service data here can be various data such as characters, pictures, voices, animations, videos, etc. Generally, the service data contained in the individual participant devices is relevant, and the service parties corresponding to the individual training member can also be relevant. A single participant device can hold service data for one service or service data of a plurality of service parties.

Under this implementation architecture, the model can be jointly trained by two or more participant devices. The model here can be used to process service data and obtain corresponding service processing results, so it can also be called a service model. The specific service data processed and the service processing results obtained depend on actual needs. For example, service data can be user financial-related data, and the obtained service processing results are evaluation results of user financial credit. For example, the service data can be customer service data, and the obtained service processing results are recommended results of customer service answers, etc. The form of service data can also be various forms of data such as texts, images, animations, audios, videos, etc. Each participant device can use the trained model to perform local service processing on local service data.

It can be understood that federated learning can be divided into horizontal federated learning (feature alignment), vertical federated learning (sample alignment), and federated transfer learning. The implementation architecture provided in this description is based on vertical federated learning, that is, the individual participant devices have overlapped sample bodies, and thus may provide the federated learning situation of partial features of the sample respectively. The sample body is a main body corresponding to the service data to be processed. For example, the service subject of financial risk assessment is a user, enterprise and/or the like.

In the binary classification scenario of the longitudinal federated learning, a stochastic gradient descent (SGD) approach or Newton and quasi-Newton approaches are generally used to optimize the model. Herein, the core idea of the stochastic gradient descent (SGD) approach is to iteratively optimize the model by using the first-order gradient of the loss function on the model parameter. However, the existing first-order optimizer only uses the first-order gradient of the loss function on the model parameter, and the convergence speed is relatively slow. The Newton approach guides parameter updates by multiplying an inverse matrix of a second derivative Hessian matrix by the first-order gradient, and the computational complexity of this approach is high. The quasi-Newton approach replaces the inverse of the second derivative Hessian matrix in the Newton approach with an n-order matrix, but the algorithm convergence speed of this approach is still slow.

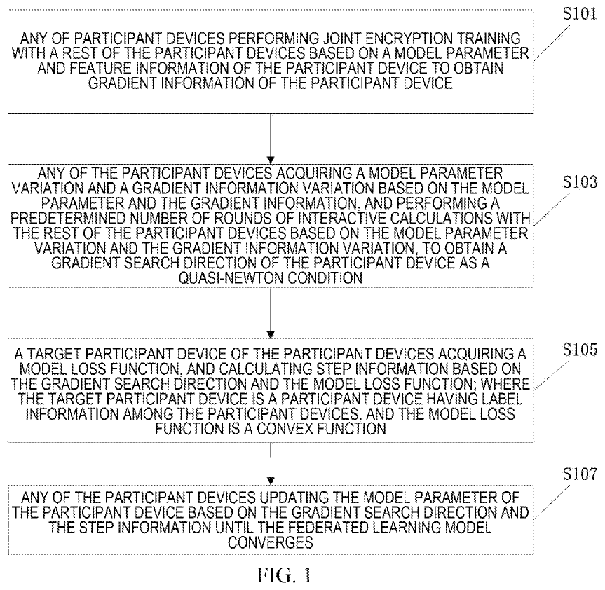

In view of this, the disclosure provides a method of training a federated learning model, which can improve the convergence speed of models in longitudinal federated learning. As shown in FIG. 1, the method of training a federated learning model includes:

In step S101, any of participant devices performs joint encryption training with a rest of the participant devices based on a model parameter and feature information of the participant device to obtain gradient information of the participant device.

In this embodiment, at least two participant devices jointly train the federated learning model, and each of the participant devices can obtain the feature information based on service data on that participant device. In the training process of the federated learning model, each of the participant devices interacts with a rest of the participant devices based on the encrypted model parameter, feature information and other information, so that each of the participant devices obtains respective gradient information.

In step S103, any of the participant devices acquires a model parameter variation and a gradient information variation based on the model parameter and the gradient information, and performs a predetermined number of rounds of interactive calculations with the rest of the participant devices based on the model parameter variation and the gradient information variation, to obtain a gradient search direction of the participant device as a quasi-Newton condition.

In the embodiment, any of the participant devices obtains a gradient search direction of each of the participant devices based on the model parameter and gradient information and through the predetermined number of rounds of interactive calculations. A respective gradient search direction obtained by each of the participant devices is equivalent to—H⁻¹g in w=w−H⁻¹g of the Newton approach. Therefore, there is no need to directly calculate the Heisenberg matrix H or the inverse matrix of the Heisenberg matrix, reducing data calculations and interactions.

In step S105, a target participant device of the participant devices acquires a model loss function, and calculates step information based on the gradient search direction and the model loss function; where the target participant device is a participant device having label information among the participant devices, and the model loss function is a convex function.

In this embodiment, since the model loss function is a convex function, based on the convexity of the model loss function, its global extreme point can be obtained by calculating its local extreme point. Based on the gradient search direction of each of the participant devices calculated in step S103, step information is selected to pre-update the model parameter until the model loss function satisfies a search stop condition, and then the model parameter is updated based on the gradient search direction and the step information.

In step S107, any of the participant devices updates the model parameter of the participant device based on the gradient search direction and the step information until the federated learning model converges.

Alternatively, in the above embodiments, any of the participant devices is any one of all participant devices participant in training of the federated learning model, regardless of whether the participant device has label information. In this embodiment, steps S101, S103, and S107 are steps that can be performed by all participant devices participant in training of the federated learning model. The target participant device is a participant device with label information among all participant devices participant in training of the federated learning model. The target participant device not only performs the processes of steps S101, S103, and S107, but also performs the processes of step S105.

In the embodiment, after each of the participant devices obtains respective gradient information of the participant device by performing joint encryption training with a rest of the participant devices, the participant device performs joint training with the rest of the participant devices based on the model parameter variation and the gradient information variation to obtain a respective gradient search direction as a quasi-Newton condition; then, the target participant device calculates the step information based on the gradient search direction and the model loss function; finally, each of the participant devices updates the model parameter of the participant device based on the gradient search direction and the step information without a calculation of an inverse matrix of the Hessian matrix. Compared with the stochastic gradient descent approach, the Newton approach and the quasi-Newton approach, the calculations and the communication are less, and fast convergence can be ensured.

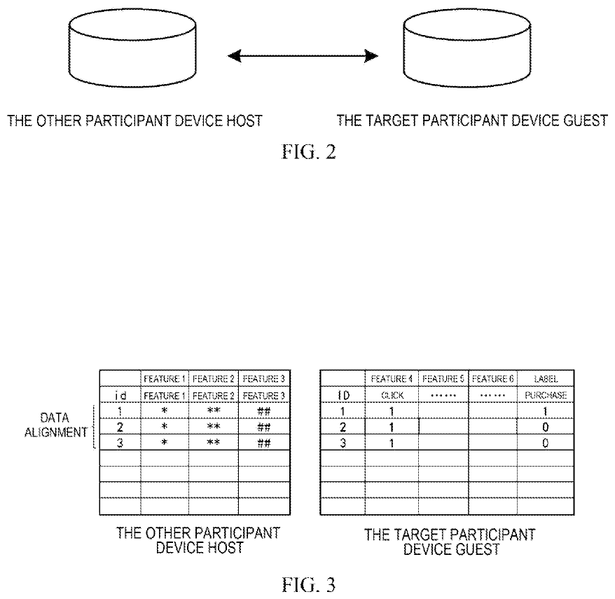

As shown in FIG. 2, the method described in the above embodiments is applied between the target participant device Guest and the rest of the participant devices Host except for the target participant device. Herein, the target participant device Guest stores first feature information and sample label information of a plurality of samples, and the rest of the participant devices Host stores second feature information of the plurality of samples. The rest of the participant devices may includes only one participant device or a plurality of participant devices. In this embodiment, taking the example of the rest of the participant devices including only one participant device, the method of training a federated learning model based on the target participant device Guest and the other participant device Host will be described in detail.

As shown in FIG. 3, in a specific embodiment, data alignment between the target participant device Guest and the other participant device Host is achieved based on shared information (such as ID information) between both the participant devices. After the alignment, the target participant device Guest and the other participant device Host each includes a plurality of samples having ID information of 1, 2, and 3, respectively. Herein, the other participant device Host includes a plurality of pieces of second feature information such as feature 1, feature 2 and feature 3; the target participant device Guest includes a plurality of pieces of first feature information such as feature 4 (click), feature 5 and feature 6, and sample label information (purchase).

For ease of further discussions of the disclosed embodiments, the number of samples of the target participant device Guest and the other participant device Host is n. Each piece of first feature information in the target participant device Guest is denoted as x_{G}, and the first feature information of all n samples in the target participant device Guest is listed as {x_{G}⁽ⁱ⁾}, and the sample label information of each sample is denoted as y, and the sample label information of all n samples is listed as {y⁽ⁱ⁾}; each piece of second feature information in the other participant device Host is denoted as x_{H}, and the second feature information of all n samples in the other participant device Host is listed as {x_{H}⁽ⁱ⁾}. Herein, i represents the i-th of n samples.

In step S101, any of the participant devices performs joint encryption training with a rest of the participant devices based on the model parameter and feature information of the participant device to obtain the gradient information of the participant device.

In this embodiment, the target participant device Guest includes a first local model built locally on the target participant device Guest, and the first local model includes a first model parameter w_{G}; correspondingly, the other participant device Host includes a second local model built locally on the other participant device Host, and the second local model includes a second model parameter w_{H}.

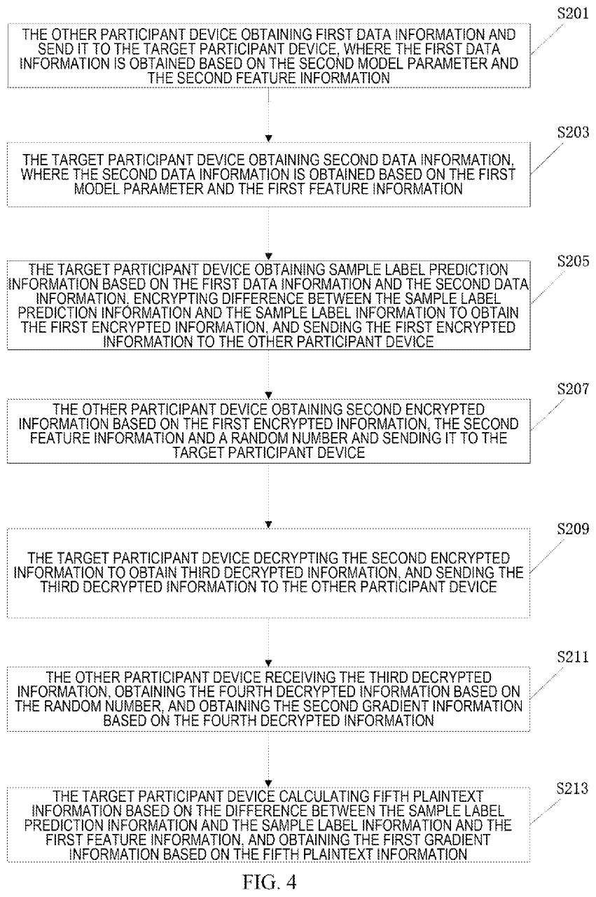

In some embodiments, in step S101, the Homomorphic Encryption algorithm or the Semi-Homomorphic Encryption algorithm is used to encrypt the interaction data during the joint encryption training process. For example, the Paillier algorithm can be used for encryption to ensure that the target participant device Guest and the other participant device Host will not be leaked during the joint training process. As shown in FIG. 4, step S101 specifically includes the following steps:

In step S201, the other participant device obtains first data information and send it to the target participant device. The first data information is obtained based on the second model parameter and the second feature information.

In this step, the other participant device Host obtains the second model parameter w_{H} of the second local model of the other participant device, calculates an inner product of the second model parameter w_{H} and the second feature information to obtain the first data information w_{H}^{T}*x_{H}, and sends the first data information to the target participant device Guest.

Alternatively, in the embodiment, the first data information w_{H}^{T}*x_{H} includes an inner product of a transpose matrix w_{H}^{T} of the second model parameter w_{H} and each piece of second feature information, and therefore the first data information includes n pieces of information corresponding to the n samples.

Alternatively, in step S201, the other participant device Host can also calculate the first regular term and send it to the target participant device Guest. The first regular term is an L2 regular term, and the first regular term is ½α∥w_{H}∥², where α represents a regular coefficient.

Alternatively, when in the first update cycle, the second model parameter w_{H} is an initial value of the initialized model parameter after initialization; when in the middle update cycle, the second model parameter w_{H} is the model parameter of the second local model updated in the previous update cycle.

In step S203, the target participant device obtains second data information, and the second data information is obtained based on the first model parameter and the first feature information.

In this step, the target participant device Guest obtains the first model parameter w_{G} of the first local model, and calculates an inner product of the first model parameter w_{G} and the first feature information to obtain the second data information w_{G}^{T}*x_{G}. Specifically, in this embodiment, the second data information w_{G}^{T}*x_{G} includes an inner product of a transpose matrix w_{G}^{T} of the first model parameter w_{G} and each piece of first feature information x_{G}.

Alternatively, in this embodiment, the target participant device Guest also calculates the second regular term. Herein, the second regular term is also an L2 regular term, and the second regular term is ½α∥w_{G}∥², where a represents the regular coefficient.

Alternatively, when in the first update cycle, the first model parameter w_{G} is an initial value of the model parameter after initialization; when in the middle update cycle, the first model parameter w_{G} is the model parameter updated by the first local model in the previous update cycle.

In steps S201 and S203, since the first model parameter w_{G} and the second model parameter w_{H} are one-dimensional vectors in the longitudinal federated LR model, the first data information obtained based on w_{G}^{T}*x_{G} and the second data information obtained based on w_{G}^{T}*x_{G} are results of matrix multiplication. When the first data information and the second data information are sent to the other participant device, the other participant cannot recover the original data information, so that the plaintext information will not be leaked during the data transmission process in steps S201 and S203, ensuring the security of data from both participants.

In step S205, the target participant device obtains sample label prediction information based on the first data information and the second data information, encrypts difference between the sample label prediction information and the sample label information to obtain the first encrypted information, and sends the first encrypted information to the other participant device.

In this step, the target participant device Guest obtains the sample label prediction information ŷ for each sample based on the first data information and the second data information. Herein, based on the sample label prediction information ŷ, the probability of binary classification of the sample can be decided, thereby solving the binary classification issue in the longitudinal federated model. Alternatively, in some embodiments, the sample label prediction information ŷ=sigmoid(w_{H}^{T}*x_{H}⁽ⁱ⁾+w_{G}^{T}*x_{G}⁽ⁱ⁾), the function sigmoid is defined as

$$σ ( x ) = \frac{1}{1 + exp ( - x )} .$$

Next, based on the sample label prediction information ŷ and the sample label information y of each sample, the difference ŷ−y between the sample label prediction information and the sample label information of each sample is calculated and encrypted to obtain the first encrypted information [[ŷ−y]], where

$$[ [ \hat{y} - y ] ] = [ [ \frac{1}{1 + exp ( - {w}_{H}^{T} * {x}_{H} - {w}_{G}^{T} * {x}_{G} )} - y ] ] .$$

Due to the use of the encryption algorithm, the encrypted information will not leak the original sample label information after being sent to the other participant device Host, ensuring data security.

Alternatively, the encryption algorithm used in this step can be a semi-homomorphic encryption algorithm Paillier, or other optional semi-homomorphic encryption algorithms or homomorphic encryption algorithms can also be used, which is not limited in this embodiment.

Finally, the target participant device Guest sends the first encrypted information [[ŷ−y]] to the other participant device Host.

In step S207, the other participant device obtains second encrypted information based on the first encrypted information, the second feature information and a random number and sends it to the target participant device.

In this embodiment, the other participant device Host obtains the second encrypted information Σᵢⁿ[[( [symbol] −yᵢ)]]x_{iH}*ϵᵢ based on a sum of respective products of the first encrypted information, the second feature information and the random number. Herein, [symbol] represents the sample label prediction information of the i-th sample, yᵢ represents the sample label of the i-th sample, x_{iH} represents the second feature information of the i-th sample, and ϵᵢ represents the random number of the i-th sample. By increasing the random number, when the other participant device Host sends the second encrypted information Σᵢⁿ[[( [symbol] −yᵢ)]]x_{iH}*ϵᵢ to the target participant device Guest, the target participant device Guest can neither restore the plaintext information, nor obtain second gradient information of the other participant device, thereby avoiding data leakage.

In step S209, the target participant device decrypts the second encrypted information to obtain third decrypted information, and sends the third decrypted information to the other participant device. Herein, the third decrypted information is obtained based on an accumulated sum of products of the difference of the sample label prediction information and the sample label information of the respective samples, the second feature information and the random number.

In this step, the decryption algorithm corresponding to the encryption algorithm in S205 is used, and the target participant device Guest decrypts the second encrypted information Σᵢⁿ[[( [symbol] −yᵢ)]]x_{iH}*ϵᵢ to obtain the third decrypted information. Then, the target participant device Guest sends the third decrypted information Σᵢⁿ( [symbol] −yᵢ)x_{iH}*ϵᵢ to the other participant device Host.

In step S211, the other participant device receives the third decrypted information, obtains the fourth decrypted information based on the random number, and obtains the second gradient information based on the fourth decrypted information.

After receiving the third decrypted information Σᵢⁿ( [symbol] −yᵢ)x_{iH}*ϵᵢ, the other participant device Host can remove the random number ϵᵢ to obtain the fourth decrypted information Σᵢⁿ( [symbol] −yᵢ)x_{iH}. Since the fourth decrypted information Σᵢⁿ( [symbol] −yᵢ)x_{iH} is an accumulated value, even if the other participant device Host is aware of x_{iH}, it cannot parse each ŷ−y, thus avoiding data leakage.

Thereafter, the other participant device Host may calculate the second gradient information

$$\frac{\partial L}{\partial {w}_{H}} = \frac{1}{n} {\sum }_{i}^{n} ( {\hat{y}}_{ι} - {y}_{i} ) {x}_{iH} + \frac{α}{n} {w}_{H}$$

of the participant based on the fourth decrypted information Σᵢⁿ( [symbol] −yᵢ)x_{iH}.

In step S213, the target participant device calculates fifth plaintext information based on the difference between the sample label prediction information and the sample label information and the first feature information, and obtains the first gradient information based on the fifth plaintext information.

In this step, the target participant device Guest obtains the fifth plaintext information Σᵢⁿ( [symbol] −yᵢ)x_{iG} based on a sum of products of the respective difference ŷ−y between the sample label prediction information and the sample label information of the samples, the respective first feature information x_{G} of the samples, and calculates the first gradient information

$$\frac{\partial L}{\partial {w}_{G}} = \frac{1}{n} {\sum }_{i}^{n} ( {\hat{y}}_{ι} - {y}_{i} ) {x}_{iG} + \frac{α}{n} {w}_{G}$$

based on the fifth plaintext information Σᵢⁿ( [symbol] −yᵢ)x_{iG}.

In the above embodiment, step S205 further includes: a target participant device calculates a loss function Loss based on the sample label prediction information and the sample label information. Alternatively, the loss function Loss may further include a first regular term and a second regular term, including:

$$Loss = \frac{1}{n} {\sum }_{i}^{n} [ {y}^{( i )} ln {\hat{y}}^{( i )} + ( 1 - {y}^{( i )} ) ln ( 1 - {\hat{y}}^{( i )} ) ] + \frac{1}{2} α {‖ {w}_{H} ‖}^{2} + \frac{1}{2} α {‖ {w}_{G} ‖}^{2} .$$

In step S103, any of the participant devices acquires the model parameter variation and the gradient information variation based on the model parameter and the gradient information, and performs the predetermined number of rounds of interactive calculations with the rest of the participant devices based on the model parameter variation and the gradient information variation to obtain the gradient search direction of the participant device as the quasi-Newton condition.

Alternatively, in the embodiment, any of the participant devices obtains the gradient search direction based on the model parameter variation and the gradient information variation and performs the predetermined number of rounds of interactive calculations with the rest of participant devices using a bidirectional loop recursion approach. That is, in the embodiment, after the target participant device Guest obtains the first gradient information and the other participant device Host obtains the second gradient information, they calculate the respective model parameter variations and gradient information variations and performs the predetermined number of interactive calculation based on the bidirectional loop recursion approach, so that the target participant device Guest obtains the first gradient search direction, and the other participant device Host obtains the second gradient search direction. Meanwhile, in the embodiment, the data calculated, transmitted and received by the target participant device Guest and the other participant device Host is obtained based on a vector product or a scalar product of at least two of the model parameter variation, the transpose matrix of the model parameter variation, the gradient information variation and the transpose matrix of the gradient information variation, without involving the operation of a large matrix. Therefore, the calculations and communications in the entire process are less, thereby ensuring rapid convergence of the model.

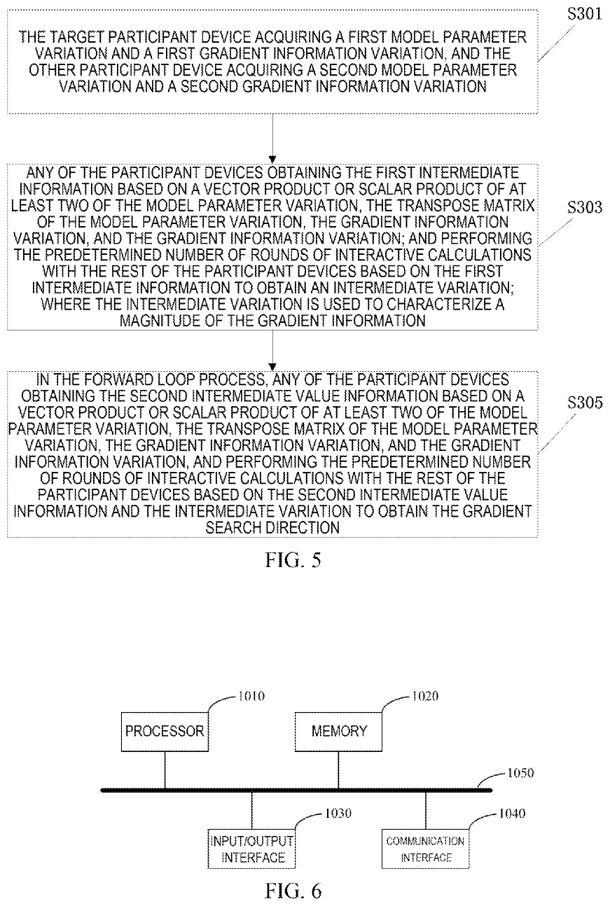

In this embodiment, as shown in FIG. 5, step S103 specifically includes:

In step S301, the target participant device Guest acquires a first model parameter variation and a first gradient information variation, and the other participant device Host acquires a second model parameter variation and a second gradient information variation.

In the embodiment, for ease of representation, g represents the gradient information, where g_{G} represents the first gradient information and g_{H} represents the second gradient information. t represents the variation Δ_{g} of the gradient information g, and then t_{G} represents the variation of the first gradient information and t_{H} represents the variation of the second gradient information. S represents the variation Δw of the model parameter, and then s_{G} represents the variation of the first model parameter and s_{H} represents the variation of the second model parameter.

In step S303, any of the participant devices performs the predetermined number of rounds of interactive calculations with the rest of participant devices based on the model parameter variation and the gradient information variation to obtain an intermediate variation; the intermediate variation is used to characterize a magnitude of the gradient information.

Alternatively, in the embodiment, a bidirectional loop algorithm may be used to calculate the gradient search direction. Herein, it includes: in the backward loop process, any of the participant devices performs the predetermined number of rounds of interactive calculations with the rest of participant devices based on first intermediate information to obtain the intermediate variation.

Herein, the predetermined number of rounds is one of 3 to 5, and the number of rounds in the backward loop is the same as that in the forward loop.

In the embodiment, after the target participant device Guest having the first gradient information variation t_{G} and the first model parameter variation s_{G} and the other participant device Host having the second gradient information variation t_{H} and the second model parameter variation s_{H} perform 3 to 5 rounds of interactive calculations, the target participant device Guest obtains the intermediate variation q_{G} of the participant device, and the other participant device Host obtains the intermediate variation q_{H} of the participant device.

At the same time, in the backward loop process, any of the participant devices exchanges the first intermediate value information with the rest of the participant devices based on the first intermediate value information of the participant device, and calculates a first global intermediate value based on the respective first intermediate value information of each of the participant devices to calculate the intermediate variation based on the first global intermediate value.

In this embodiment, the first intermediate value information in the backward loop process includes, ρ_{G}, ρ_{H} and α_{G}, α_{H}. After the target participant device Guest and the other participant device Host calculate their first intermediate value information based on their model parameter variation and gradient information variation, the first intermediate value information of the respective participant devices needs to be exchanged to obtain a sum of the first global intermediate value p and a. Alternatively, the first global intermediate value can be the sum of the first intermediate value information of the respective participant devices, or it can be set according to demand. This specification is not limited to this.

Specifically, the target participant device Guest and the other participant device Host respectively obtain the first intermediate value information ρ_{G} and ρ_{H} based on products of the transpose matrices of their gradient information variations and their model parameter variations, exchange the first intermediate value information ρ_{G} and ρ_{H}, and then obtain the first global intermediate value ρ; and they combine the first global intermediate value ρ, the transpose matrices of the model parameter variations, and the gradient information to calculate the first intermediate value information α_{G} and α_{H}, exchange the first intermediate value information α_{G} and α_{H}, then calculate the first global intermediate value a, and finally calculate their intermediate variations based on a.

The steps of the backward loop in this embodiment will be further described in detail below in conjunction with specific implementations, including:

In step S401, the target participant device Guest initializes q_{G}=g_{kG}, and the other participant device Host initializes q_{H}=g_{kH}.

In step S403, the following steps are iterated by L rounds, i is from L−1 to 0, and j is from k−1 to k−L. Herein, L represents the predetermined number of rounds, and L=3 to 5; k represents the current number of rounds.
1) The other participant device Host calculates intermediate process variables ρ_{jH}=t_{jH}^{T}s_{jH}.
2) The target participant device Guest calculates intermediate process variables ρ_{jG}=t_{jG}^{T}s_{jG}.
3) After the target participant device Guest and the other participant device Host exchange values of ρ, they calculate

$${ρ}_{j} = \frac{1}{{ρ}_{jH} + {ρ}_{jG}} .$$

4) The other participant device Host calculates intermediate process variables α_{iH}=ρⱼs_{jH}^{T}q_{H};
5) The target participant device Guest calculates intermediate process variables α_{iG}=ρⱼs_{jG}^{T}q_{G}.
6) After the target participant device Guest and the other participant device Host exchange values of α, they calculate αᵢ=α_{iH}+α_{iG}.
7) The other participant device Jost calculate the intermediate variation by the device hos.
8) The target participant device Guest calculates the intermediate variation q_{G}=q_{G}−αᵢt_{jG}.

In the calculation and exchange process of each intermediate process variable of each step in step S403, it is the calculation and exchange of vector multiplication or scalar multiplication, which does not involve the calculation of large matrices, so calculations and communications in the training process are relatively less, which can not only ensure the rapid convergence of the model, but also improve the hardware processing rate of the target participant device and the other participant device.

In step S305, any of the participant devices performs the predetermined number of rounds of interactive calculations with the rest of the participant devices based on the intermediate variation to obtain the gradient search direction.

Alternatively, step S305 further includes: any of the participant devices calculates second intermediate value information of the participant device based on the intermediate variation of the participant device; any of the participant devices exchanges the second intermediate value information with the rest of the participant devices based on the second intermediate value information of the participant device and calculates a second global intermediate value based on the respective second intermediate value information of each of the participant devices to calculate the gradient search direction based on the second global intermediate value.

In this embodiment, a bidirectional loop algorithm can be used to calculate the gradient search direction. Herein, it includes: in the forward loop process, any of the participant devices obtains the second intermediate value information based on a vector product or scalar product of at least two of the model parameter variation, the transpose matrix of the model parameter variation, the gradient information variation, and the gradient information variation; and performs the predetermined number of rounds of interactive calculations with the rest of the participant devices based on the second intermediate value information to obtain the gradient search direction.

In the embodiment, after the target participant device Guest having an intermediate variation q_{G} and the other participant device Host having an intermediate variation q_{H}, perform 3 to 5 rounds of interactive calculations, the target participant device Guest obtains the first gradient search direction p_{kG} of the participant device, and the other participant device Host obtains the second gradient search direction p_{kH} of the participant device.

The steps of the forward cycle in this embodiment will be further described in detail below in conjunction with specific implementations, including:
In step S501, any of the participant devices obtains first scalar information based on the transpose matrix of the model parameter variation and the model parameter variation, and obtains second scalar information based on the transpose matrix of the gradient information variation and the gradient information variation.

In the embodiment, the first scalar information is obtained based on the product s_{G}^{T}s_{G} of the transpose matrix of the first model parameter variation s_{G} and the first model parameter variation s_{G}, and the second scalar information is obtained based on the product t_{G}^{T}t_{G} of the transpose matrix of the first gradient information variation and the first gradient information variation.

In step S503, any of the participant devices interact with the rest of the participant devices to obtain third scalar information and fourth scalar information of the rest of the participant devices; the third scalar information is obtained based on the transpose matrix of the model parameter variation and the model parameter variation of the rest of the participant devices, and the fourth scalar information is obtained based on the transpose matrix of the gradient information variation and the gradient information variation of the rest of the participant devices.

In the embodiment, the third scalar information is obtained based on the product s_{H}^{T}s_{H} of the transpose matrix of the second model parameter variation s_{H} and the second model parameter variation s_{H}, and the fourth scalar information is obtained based on the product t_{H}^{T}t_{H} of the transpose matrix of the second gradient information variation and the second gradient information variation.

In this embodiment, the target participant device Guest exchanges the first scalar information, the second scalar information, the third scalar information, and the fourth scalar information with the other participant device Host, so that the target participant device guest and the other participant device Host both have the above information.

In step S505, any of the participant devices calculates the second intermediate value information based on the first scalar information s_{G}^{T}s_{G}, the second scalar information t_{G}^{T}t_{G}, the third scalar information s_{H}^{T}s_{H}, the fourth scalar information t_{H}^{T}t_{H}, and the intermediate variation q_{G} and q_{H}, and exchanges the second intermediate value information with the rest of the participant devices and calculates the second global intermediate value based on the second intermediate value information of each of the participant devices to calculate the gradient search direction based on the second global intermediate value.

In this embodiment, the second intermediate value information in the forward loop process includes β. After the target participant device Guest and the other participant device Host calculate their respective second intermediate value information β, the second intermediate value information of the respective participant devices needs to be exchanged to obtain the second global intermediate value. Alternatively, the second global intermediate value can be the sum of the second intermediate value information of the respective participant devices, or it can be set according to demand, and this specification is not limited to this.

Alternatively, step S505 further includes:

In step S601,

$${γ}_{k} = \frac{{s}_{k - 1 ( H )}^{T} {t}_{k - 1 ( H )} + {s}_{k - 1 ( G )}^{T} {t}_{k - 1 ( G )}}{{t}_{k - 1 ( H )}^{T} {t}_{k - 1 ( H )} + {t}_{k - 1 ( G )}^{T} {t}_{k - 1 ( G )}}$$

is calculated based on the values of the first scalar information s_{G}^{T}s_{G}, the second scalar information t_{G}^{T}t_{G}, the third scalar information s_{H}^{T}s_{H}, and the fourth scalar information t_{H}^{T}t_{H} exchanged by the target participant device Guest and the other participant device Host.

In step S603, the target participant device Guest and the other participant device Host calculates D₀=γₖI respectively, where I is the diagonal matrix.

In step S605, the other participant device Host calculates z_{H}=D₀·q_{H}, the target participant device Guest calculates z_{G}=D₀·q_{G}.

In step S607, L rounds of iterations are performed, where i from 0 to L−1, j from k−L to k−1. Herein, L represents the predetermined number of rounds, and L=one of 3 to 5; k represents the current number of rounds.
1) The other participant device Host calculates β_{H}=ρⱼt_{H}^{T}z_{H};
2) The target participant device Guest calculates β_{G}=ρⱼt_{jG}^{T}z_{G};
3) After the target participant device Guest and the other participant device Host exchange values of β, they calculate βᵢ=β_{H}+β_{G}.
4) The other participant device Host calculates z_{H}=z_{H}+(αᵢ−βᵢ)s_{jH};
5) The target participant device Guest calculates z_{G}=z_{G}+(αᵢ−βᵢ)s_{jG}.

In step S609, the other participant device Host obtains a second gradient search direction p_{kH}=−z_{H}, the target participant device Guest obtains a first gradient search direction p_{kG}=−z_{G}.

In the above embodiments, except for one multiplication of the unit matrix and the vector, all other calculations are vector multiplication or scalar multiplication, which does not involve the calculation of large matrices, thereby reducing calculations in the process of training the model. At the same time, the variables exchanged by both the participants are scalar results after an inner product of vectors, thereby ensuring data security, and reducing communications during data transmission, which not only ensures fast convergence of the model, but also improves the hardware processing rate of the target participant device and other participant device. Alternatively, in some specific embodiments, for the same sample data, in one update cycle, the method of training a federated learning model described in embodiments of the disclosure only requires three rounds of iterations to enable the model converge; while using the gradient descent approach, dozens of iterations are required to ensure the model convergence, so the method of training a federated learning model described in the embodiments of the disclosure can improve the convergence speed of the model.

In step S105, the target participant device acquires the model loss function, and calculates the step information based on the gradient search direction and the model loss function.

In some embodiments, in step S105, the target participant device acquires the model loss function, and calculates the step information based on the gradient search direction and the model loss function, including:
In step S701, the target participant device obtains the sample label information, and obtains the sample label prediction information based on the model parameter and the feature information of the target participant device, and the first data information of a rest of the participant devices; where the first data information is obtained based on the model parameter and the feature information of the rest of the participant devices.

In this embodiment, the target participant device Guest first calculates a product of the transpose matrix of the model parameter and the feature information based on the model parameter and the feature information to obtain the second data information w_{G}^{T}*x_{G}; then, the target participant device Guest interacts with the other participant device Host based on the second data information to obtain the first data information of the other participant device Host; finally, the target participant device Guest obtains the sample label prediction information based on the first data information, the second data information, and the predetermined model function.

Alternatively, the default model function is the function sigmoid, the sample label prediction information ŷ=sigmoid(w_{H}^{T}*x_{H}⁽ⁱ⁾+w_{G}^{T}*x_{G}⁽ⁱ⁾), and the function sigmoid is defined as

$$σ ( x ) = \frac{1}{1 + exp ( - x )} .$$

In step S703, the target participant device calculates the loss function based on the sample label prediction information and the sample label information.

In the embodiment, the loss function

$$Loss = \frac{1}{n} {\sum }_{i}^{n} [ {y}^{( i )} ln {\hat{y}}^{( i )} + ( 1 - {y}^{( i )} ) ln ( 1 - {\hat{y}}^{( i )} ) ] + \frac{1}{2} α {‖ {w}_{H} ‖}^{2} + \frac{1}{2} α {‖ {w}_{G} ‖}^{2} .$$

In step S705, the target participant device determines whether the loss function satisfies a predetermined condition, and based on the loss function satisfying the predetermined condition, determines current step information as final step information; based on the loss function dissatisfying a predetermined condition, reduces the value of the step information and recalculate the loss function.

In the embodiment, the predetermined condition may be an Armijo condition. Thus, it may be determined whether the loss function satisfies the Armijo condition, including: Loss(y, x_{H}, x_{G}, w_{H}+λp_{H}, w_{G}+λp_{G})≤Loss(y, x_{H}, x_{G}, w_{H}, w_{G})+c₁λ(g_{H}^{T}p_{H}+g_{G}^{T}p_{G}), where c₁ is the hyperparameter (e.g., the value 1E−4 may be taken).

If the loss function satisfies the Armijo condition, the current step information is used as the final step information λ; if the loss function does not satisfy the Armijo condition, the value of the step information will be reduced, for example, ½ of the pervious value, and after the model parameters of both the participants are updated based on the reduced step information and the first and second gradient search directions, the loss function is recalculated until the loss function does not satisfy the Armijo condition.

Thereafter, the first model parameter may be updated based on the obtained step information and the first gradient search direction, where w_{G+1}=w_{G}+λp_{G}.

When the gradient changes on both sides are stable, that is, when ∥gₖ∥≤ε(the threshold), training is stopped and the model update is completed.

It should be noted that the method according to the embodiments of the disclosure can be implemented by a single device, such as a computer or server, etc. The method of the embodiments can also be applied in a distributed scenario, where a plurality of devices cooperate with each other to implement the method. In this distributed scenario, one device among the plurality of devices can only perform one or more steps in the method of the embodiments, and the plurality of devices will interact with each other to implement the method.

It should be noted that some embodiments of the disclosure have been described above. Other embodiments are within the scope of the appended claims. In some cases, the actions or steps described in the claims may be performed in a different order than that in the above embodiments and still achieve the desired results. In addition, the processes depicted in the drawings do not necessarily require a specific order or sequential order shown to achieve the desired results. In some embodiments, multitasking and parallel processing are also possible or may be advantageous.

Based on the same inventive concept, corresponding to any of the above embodiments, the disclosure also provides an electronic device including a memory, a processor, and a computer program stored on the memory and executable on the processor, and the processor, when executing the program, implements any of the methods described in the above embodiments.

FIG. 6 shows a schematic diagram of a more specific hardware structure of an electronic device according to the embodiment of the disclosure. The apparatus may include: a processor 1010, a memory 1020, input/output interface 1030, a communication interface 1040 and a bus 1050. Herein, the processor 1010, the memory 1020, the input/output interface 1030 and the communication interface 1040 are connected to each other within the device via a bus 1050.

The processor 1010 can be implemented using a general-purpose CPU (Central Processing Unit, Central Processor), a microprocessor, an application-specific integrated circuit (ASIC), or one or more integrated circuits, etc., for executing related programs to implement the technical solutions provided in the embodiments of this description.

The memory 1020 can be implemented in the form of ROM (Read Only Memory), RAM (Stochastic Access Memory), static storage devices, dynamic storage devices, etc. The memory 1020 can store operating systems and other application programs. When implementing the technical solutions provided in the embodiments of this description through software or firmware, the relevant program code is stored in the memory 1020 and called and executed by the processor 1010.

The input/output interface 1030 is used to connect the input/output module to achieve information input and output. The input/output module can be configured as a component in the device (not shown in the figure) or externally connected to the device to provide corresponding functions. The input device can include a keyboard, a mouse, a touch screen, a microphone, various sensors, etc., and the output device can include a display, a speaker, a vibrator, an indicator light, etc.

The communication interface 1040 is used to connect communication modules (not shown) to achieve communication interaction between this device and other devices. The communication module can communicate in a wired way (such as USB, network cable, etc.) or a wireless way (such as mobile networks, WIFI, Bluetooth, etc.).

The bus 1050 includes a path for transmitting information between various components of the device (such as the processor 1010, the memory 1020, the input/output interface 1030, and the communication interface 1040).

It should be noted that although the above device is only shown to include the processor 1010, the memory 1020, the input/output interface 1030, the communication interface 1040, and the bus 1050, the device may also include other components necessary for normal operations in the specific implementation process. In addition, those skilled in the art can understand that the above device may only include the components necessary to implement the embodiments of this specification, without including all the components as shown.

The electronic device of the above embodiment is used to implement the corresponding method in any of the above embodiments, and has the beneficial effects of the corresponding method embodiments, which will not be repeated here.

Based on the same inventive concept, corresponding to any of the above embodiments, the disclosure also provides a non-transitory computer-readable storage medium, the non-transitory computer-readable storage medium storing computer instructions for causing the computer to perform the method as described in any of the embodiments.

Computer-readable media of the embodiment include both permanent and non-permanent, removable and non-removable media. Information can be computer-readable instructions, data structures, modules of programs, or other data. Examples of storage media for computers include, but are not limited to, a phase change memory (PRAM), a static stochastic access memory (SRAM), a dynamic stochastic access memory (DRAM), other types of stochastic access memory (RAM), a read-only memory (ROM), an electrically erasable programmable read-only memory (EEPROM), a flash memory, or other memory technologies, a read-only optical disk read-only memory (CD-ROM), a digital versatile optical disk (DVD), or other optical storages, a magnetic cassette tape, a magnetic tape magnetic disk storage, or any other non-transmission medium that can be used to store information that can be accessed by computing devices.

The computer instructions stored in the storage medium of the above embodiments are used to cause the computer to execute the method as described in any of the embodiments, and have the beneficial effects of the corresponding method embodiments, which are not repeated here.

Ordinary technicians in the field should understand that any of the above embodiments is discussed only for illustration without implying that the scope of the disclosure (including the claims) is limited to these examples; under the spirit of the disclosure, the technical features of the above embodiments or different embodiments can also be combined, and the steps can be implemented in any order, and there are many other changes in different aspects of the disclosure as described above, which are not provided in detail for simplicity.

In addition, to simplify the description and discussion, and in order not to make the disclosed embodiments difficult to understand, the known power/ground connections with integrated circuit (IC) chips and other components may or may not be shown in the accompanying drawings. In addition, the device can be shown in the form of a block diagram to avoid making the disclosed embodiments difficult to understand, and this also takes into account the fact that the details of the implementation of these block diagram devices are highly dependent on the platform on which the disclosed embodiments are to be implemented (i.e., these details should be fully within the understanding of those skilled in the art). In the case where specific details (such as circuits) are explained to describe example embodiments of the disclosure, it will be apparent to those skilled in the art that the disclosed embodiments can be implemented without these specific details or with changes in these specific details. Therefore, these descriptions should be considered illustrative rather than restrictive.

Although specific embodiments of the disclosure have been described, many substitutions, modifications, and variations of these embodiments will be apparent to those skilled in the art from the foregoing description. For example, other memory architectures (such as dynamic RAM (DRAM)) can use the discussed embodiments.

The disclosure is intended to cover all such substitutions, modifications, and variations falling within the broad scope of the appended claims. Therefore, any omissions, modifications, equivalent substitutions, improvements, etc. made within the spirit and principles of the disclosure should be included in the scope of protection of the disclosure.

1. A method of training a federated learning model, comprising:
any participant device of participant devices performing joint encryption training with a rest of the participant devices based on a model parameter and feature information of the participant device, to obtain gradient information of the participant device;
any participant device of the participant devices acquiring a model parameter variation and a gradient information variation based on the model parameter and the gradient information, and performing a predetermined number of rounds of interactive calculations with the rest of the participant devices based on the model parameter variation and the gradient information variation, to obtain a gradient search direction of the participant device as a quasi-newton condition;
a target participant device of the participant devices acquiring a model loss function, and calculating step information based on the gradient search direction and the model loss function; wherein the target participant device is a participant device having label information among the participant devices, and the model loss function is a convex function; and
any participant device of the participant devices updating the model parameter of the participant device based on the gradient search direction and the step information, until the federated learning model converges.

2. The method according to claim 1, wherein any participant device of the participant devices performing the predetermined number of rounds of interactive calculations with the rest of the participant devices using a bidirectional recursion approach and based on the model parameter variation and the gradient information variation to obtain the gradient search direction as the quasi-newton condition comprises:
any participant device of the participant devices performing the predetermined number of rounds of interactive calculations with the rest of the participant devices based on the model parameter variation and the gradient information variation, to obtain an intermediate variation; wherein the intermediate variation is used to characterize a magnitude of the gradient information; and
any participant device of the participant devices performing the predetermined number of rounds of interactive calculations with the rest of the participant devices based on the intermediate variation, to obtain the gradient search direction.

3. The method according to claim 2, wherein any participant device of the participant devices performing the predetermined number of rounds of interactive calculations with the rest of the participant devices based on the model parameter variation and the gradient information variation to obtain the intermediate variation comprises:
any participant device of the participant devices calculating first intermediate value information of the participant device based on the model parameter variation and the gradient information variation of the participant device, exchanging the first intermediate value information with the rest of the participant devices, and calculating a first global intermediate value based on the first intermediate value information of respective participant devices of the participant devices, to calculate the intermediate variation based on the first global intermediate value.

4. The method according to claim 3, wherein the first intermediate value information is obtained based on a product of a transpose matrix of the gradient information variation and the model parameter variation.

5. The method according to claim 3, wherein any participant device of the participant devices performing the predetermined number of rounds of interactive calculations with the rest of the participant devices based on the intermediate variation to obtain the gradient search direction further comprises:
any participant device of the participant devices calculating second intermediate value information of the participant device based on the intermediate variation of the participant device; and
any participant device of the participant devices exchanging the second intermediate value information with the rest of the participant devices based on the second intermediate value information of the participant device, and calculating a second global intermediate value based on the second intermediate value information of respective participant devices of the participant devices, to calculate the gradient search direction based on the second global intermediate value.

6. The method of claim 5, wherein any participant device of the participant devices calculating the second intermediate value information of the participant device based on the intermediate variation of the participant device comprises:
any participant device of the participant devices obtaining first scalar information based on a transpose matrix of the model parameter variation and the model parameter variation, and obtaining second scalar information based on a transpose matrix of the gradient information variation and the gradient information variation;
any participant device of the participant devices interacting with the rest of the participant devices to obtain third scalar information and fourth scalar information; wherein the third scalar information is obtained based on a transpose matrix of a model parameter variation and the model parameter variation of the rest of the participant devices, and the fourth scalar information is obtained based on a transpose matrix of a gradient information variation and the gradient information variation of the rest of the participant devices; and
any participant device of the participant devices calculating the second intermediate value information of the participant device based on the first scalar information, the second scalar information, the third scalar information, the fourth scalar information and the intermediate variation.

7. The method of claim 6, wherein the first global intermediate value is a sum of the first intermediate value information of respective participant devices of the participant devices, and the second global intermediate value is a sum of the second intermediate value information of respective participant devices of the participant devices.

8. The method according to claim 1, wherein the target participant device acquiring the model loss function and calculates the step information based on the gradient search direction and the model loss function comprises:
the target participant device acquiring sample label information, and obtaining sample label prediction information based on a model parameter and feature information of the target participant device and first data information of the rest of the participant devices; wherein the first data information is obtained based on the model parameter and the feature information of the rest of the participant devices;
the target participant device calculating the model loss function based on the sample label prediction information and the sample label information; and
the target participant device determining whether the model loss function satisfies a predetermined condition, and based on the model loss function satisfying the predetermined condition, determining current step information as final step information; and based on the model loss function dissatisfying the predetermined condition, reducing a value of the step information and recalculating the model loss function.

9. The method according to claim 8, wherein obtaining the sample label prediction information based on the model parameter and the feature information of the target participant device and the data information of the rest of the participant devices comprises:
the target participant device calculating a product of a transpose matrix of the model parameter and the feature information based on the model parameter and the feature information of the target participant device, to obtain second data information;
the target participant device interacting with the rest of the participant devices based on the second data information to obtain the first data information of the rest of the participant devices; and
the target participant device obtaining the sample label prediction information based on the first data information, the second data information and a predetermined model function.

10-11. (canceled)

12. The method according to claim 9, wherein the product comprises a vector product or a scalar product.

13. An electronic device comprising a memory, a processor, and a computer program stored on the memory and executable on the processor, wherein the processor, when executing the program, performs actions, the actions comprising:
any participant device of participant devices performing joint encryption training with a rest of the participant devices based on a model parameter and feature information of the participant device, to obtain gradient information of the participant device;
any participant device of the participant devices acquiring a model parameter variation and a gradient information variation based on the model parameter and the gradient information, and performing a predetermined number of rounds of interactive calculations with the rest of the participant devices based on the model parameter variation and the gradient information variation, to obtain a gradient search direction of the participant device as a quasi-newton condition;
a target participant device of the participant devices acquiring a model loss function, and calculating step information based on the gradient search direction and the model loss function;
wherein the target participant device is a participant device having label information among the participant devices, and the model loss function is a convex function; and
any participant device of the participant devices updating the model parameter of the participant device based on the gradient search direction and the step information, until the federated learning model converges.

14. The electronic device according to claim 13, wherein any participant device of the participant devices performing the predetermined number of rounds of interactive calculations with the rest of the participant devices using a bidirectional recursion approach and based on the model parameter variation and the gradient information variation to obtain the gradient search direction as the quasi-newton condition comprises:
any participant device of the participant devices performing the predetermined number of rounds of interactive calculations with the rest of the participant devices based on the model parameter variation and the gradient information variation, to obtain an intermediate variation; wherein the intermediate variation is used to characterize a magnitude of the gradient information; and
any participant device of the participant devices performing the predetermined number of rounds of interactive calculations with the rest of the participant devices based on the intermediate variation, to obtain the gradient search direction.

15. The electronic device according to claim 14, wherein any participant device of the participant devices performing the predetermined number of rounds of interactive calculations with the rest of the participant devices based on the model parameter variation and the gradient information variation to obtain the intermediate variation comprises:
any participant device of the participant devices calculating first intermediate value information of the participant device based on the model parameter variation and the gradient information variation of the participant device, exchanging the first intermediate value information with the rest of the participant devices, and calculating a first global intermediate value based on the first intermediate value information of respective participant devices of the participant devices, to calculate the intermediate variation based on the first global intermediate value.

16. The electronic device according to claim 15, wherein the first intermediate value information is obtained based on a product of a transpose matrix of the gradient information variation and the model parameter variation.

17. The electronic device according to claim 15, wherein any participant device of the participant devices performing the predetermined number of rounds of interactive calculations with the rest of the participant devices based on the intermediate variation to obtain the gradient search direction further comprises:
any participant device of the participant devices calculating second intermediate value information of the participant device based on the intermediate variation of the participant device; and
any participant device of the participant devices exchanging the second intermediate value information with the rest of the participant devices based on the second intermediate value information of the participant device, and calculating a second global intermediate value based on the second intermediate value information of respective participant devices of the participant devices, to calculate the gradient search direction based on the second global intermediate value.

18. The electronic device of claim 17, wherein any participant device of the participant devices calculating the second intermediate value information of the participant device based on the intermediate variation of the participant device comprises:
any participant device of the participant devices obtaining first scalar information based on a transpose matrix of the model parameter variation and the model parameter variation, and obtaining second scalar information based on a transpose matrix of the gradient information variation and the gradient information variation;
any participant device of the participant devices interacting with the rest of the participant devices to obtain third scalar information and fourth scalar information; wherein the third scalar information is obtained based on a transpose matrix of a model parameter variation and the model parameter variation of the rest of the participant devices, and the fourth scalar information is obtained based on a transpose matrix of a gradient information variation and the gradient information variation of the rest of the participant devices; and
any participant device of the participant devices calculating the second intermediate value information of the participant device based on the first scalar information, the second scalar information, the third scalar information, the fourth scalar information and the intermediate variation.

19. The electronic device of claim 18, wherein the first global intermediate value is a sum of the first intermediate value information of respective participant devices of the participant devices, and the second global intermediate value is a sum of the second intermediate value information of respective participant devices of the participant devices.

20. The electronic device according to claim 13, wherein the target participant device acquiring the model loss function and calculates the step information based on the gradient search direction and the model loss function comprises:
the target participant device acquiring sample label information, and obtaining sample label prediction information based on a model parameter and feature information of the target participant device and first data information of the rest of the participant devices; wherein the first data information is obtained based on the model parameter and the feature information of the rest of the participant devices;
the target participant device calculating the model loss function based on the sample label prediction information and the sample label information; and
the target participant device determining whether the model loss function satisfies a predetermined condition, and based on the model loss function satisfying the predetermined condition, determining current step information as final step information; and based on the model loss function dissatisfying the predetermined condition, reducing a value of the step information and recalculating the model loss function.

21. The electronic device according to claim 20, wherein obtaining the sample label prediction information based on the model parameter and the feature information of the target participant device and the data information of the rest of the participant devices comprises:
the target participant device calculating a product of a transpose matrix of the model parameter and the feature information based on the model parameter and the feature information of the target participant device, to obtain second data information;
the target participant device interacting with the rest of the participant devices based on the second data information to obtain the first data information of the rest of the participant devices; and
the target participant device obtaining the sample label prediction information based on the first data information, the second data information and a predetermined model function.

22. A non-transitory computer readable storage medium storing computer instructions for causing a computer to perform actions, the actions comprising:
any participant device of participant devices performing joint encryption training with a rest of the participant devices based on a model parameter and feature information of the participant device, to obtain gradient information of the participant device;
any participant device of the participant devices acquiring a model parameter variation and a gradient information variation based on the model parameter and the gradient information, and performing a predetermined number of rounds of interactive calculations with the rest of the participant devices based on the model parameter variation and the gradient information variation, to obtain a gradient search direction of the participant device as a quasi-newton condition;
a target participant device of the participant devices acquiring a model loss function, and calculating step information based on the gradient search direction and the model loss function; wherein the target participant device is a participant device having label information among the participant devices, and the model loss function is a convex function; and
any participant device of the participant devices updating the model parameter of the participant device based on the gradient search direction and the step information, until the federated learning model converges.
